(19) United States
(12) Patent Application Publication
(10) Pub. No.: US 2023/0074326 A1
(43) Pub. Date: Mar. 9, 2023

(54) Ethylene/Butene Multi-Block Copolymer and Process for Producing Same

(71) Applicant: Dow Global Technologies LLC, Midland, MI (US)

(72) Inventors: Stacy L. Pesek, Pearland, TX (US); Jeffrey C. Munro, Bellaire, TX (US); Zhe Zhou, Lake Jackson, TX (US)

(21) Appl. No.: 17/788,903

(22) PCT Filed: Dec. 23, 2020
(86) PCT No.: PCT/US2020/066870

§ 371 Date: Jun. 24, 2022

Related U.S. Application Data
(60) Provisional application No. 62/954,247, filed on Dec. 27, 2019.

(51) Int. Cl. C08F 297/08

(52) U.S. Cl. CPC C08F 297/083; C08F 2410/01; C08F 2500/17

(57) ABSTRACT

The present disclosure provides a process. In an embodiment, the process includes contacting ethylene and butene under polymerization conditions at a temperature greater than 125C with a catalyst system. The catalyst system includes (i) a first polymerization catalyst having the structure of Formula (III), (ii) a second polymerization catalyst having the structure of Formula (I), and (iii) a chain shuttling agent. The process includes forming an ethylene/butene multi-block copolymer having LCB/1000C greater than or equal to 0.06. The present disclosure provides the resultant composition produced by the process. In an embodiment, the composition includes an ethylene/butene multi-block copolymer having LCB/1000C greater than or equal to 0.06.

### BACKGROUND

Ethylene/butene multi-block copolymer provides the benefits of both the durability and high temperature resistance of high density polyethylene while maintaining key properties of elastomeric, low density polyolefin such as elastic behavior, flexibility, and processability. Ethylene/butene multi-block copolymer typically contains high density “hard” segments and low density “soft” segments. Rheological properties, including rheology ratio, can be modified in a polyolefin by incorporating long chain branches within the polymer molecule.

The art recognizes the need for ethylene/butene multi-block copolymer with improved shear-thinning rheology for applications such as injection molded articles, polymer extrusion/processing, and thin film production.

### SUMMARY

The present disclosure provides a process. In an embodiment, the process includes contacting ethylene and butene under polymerization conditions at a temperature greater than 125° C. with a catalyst system. The catalyst system includes (i) a first polymerization catalyst having the structure of Formula (III), (ii) a second polymerization catalyst having the structure of Formula (I), and (iii) a chain shuttling agent. The process includes forming an ethylene/butene multi-block copolymer having LCB/1000C greater than or equal to 0.06.

The present disclosure provides the resultant composition produced by the process. In an embodiment, the composition includes an ethylene/butene multi-block copolymer having LCB/1000C greater than or equal to 0.06.

### BRIEF DESCRIPTION OF THE DRAWINGS

FIG. 1 is a chart showing the chemical structures for different types of carbon-carbon double bonds (unsaturation in polymer chain) for vinylene, trisubstituted, vinyl, and vinylidene.

FIG. 2 is a graph showing rheology ratio (RR) as a function of viscosity measured at 0.1 rad/s for inventive examples and comparative samples of ethylene/butene multi-block copolymer in accordance with an embodiment of the present disclosure.

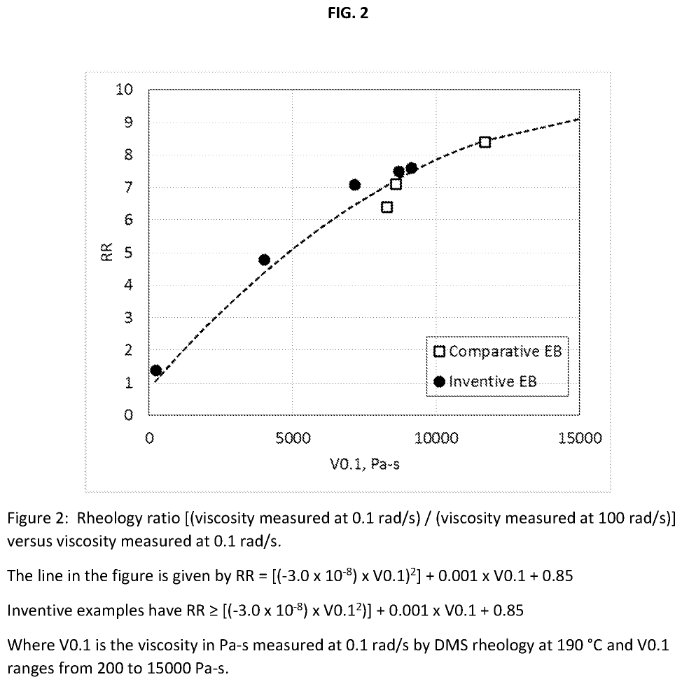

FIG. 3 is a graph showing rheology ratio (RR) as a function of viscosity measured at 100 rad/s for inventive examples and comparative samples in accordance with an embodiment of the present disclosure.

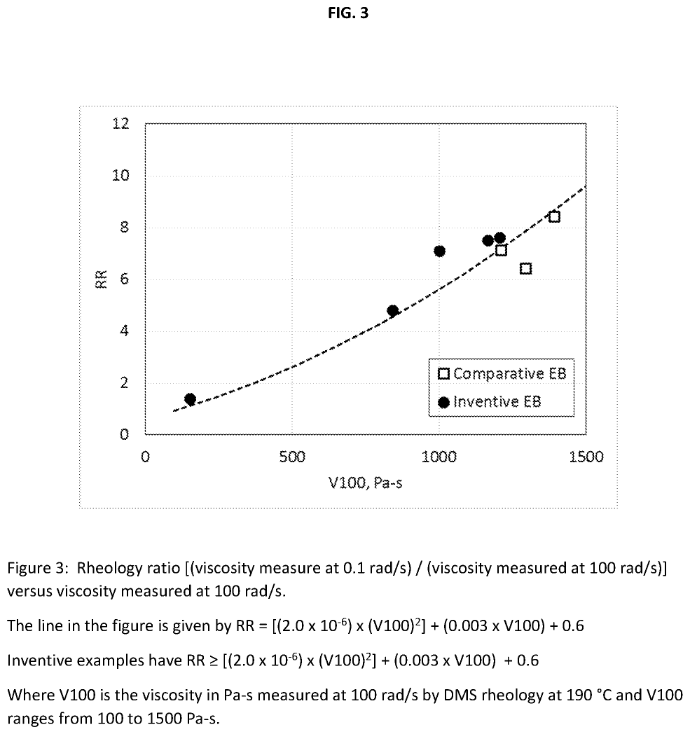

### DEFINITIONS

Any reference to the Periodic Table of Elements is that as published by CRC Press, Inc., 1990-1991. Reference to a group of elements in this table is by the new notation for numbering groups.

For purposes of United States patent practice, the contents of any referenced patent, patent application or publication are incorporated by reference in their entirety (or its equivalent U.S. version is so incorporated by reference) especially with respect to the disclosure of definitions (to the extent not inconsistent with any definitions specifically provided in this disclosure) and general knowledge in the art.

The numerical ranges disclosed herein include all values from, and including, the lower and upper value. For ranges containing explicit values (e.g., 1 or 2, or 3 to 5, or 6, or 7), any subrange between any two explicit values is included (e.g., the range 1-7 above includes the subranges of from 1 to 2; from 2 to 6; from 5 to 7; from 3 to 7; from 5 to 6; etc.).

Unless stated to the contrary, implicit from the context, all parts and percents are based on weight and all test methods are current as of the filing date of this disclosure.

The terms “blend” or “polymer blend,” as used herein, is a blend of two or more polymers. Such a blend may or may not be miscible (not phase separated at molecular level). Such a blend may or may not be phase separated. Such a blend may or may not contain one or more domain configurations, as determined from transmission electron spectroscopy, light scattering, x-ray scattering, and other methods known in the art.

The term “composition” refers to a mixture of materials which comprise the composition, as well as reaction products and decomposition products formed from the materials of the composition.

The terms “comprising,” “including,” “having” and their derivatives, are not intended to exclude the presence of any additional component, step or procedure, whether or not the same is specifically disclosed. In order to avoid any doubt, all compositions claimed through use of the term “comprising” may include any additional additive, adjuvant, or compound, whether polymeric or otherwise, unless stated to the contrary. In contrast, the term “consisting essentially of” excludes from the scope of any succeeding recitation any other component, step, or procedure, excepting those that are not essential to operability. The term “consisting of” excludes any component, step, or procedure not specifically delineated or listed. The term “or,” unless stated otherwise, refers to the listed members individually as well as in any combination. Use of the singular includes use of the plural and vice versa.

An “ethylene-based polymer” is a polymer that contains more than 50 weight percent (wt %) polymerized ethylene monomer (based on the total amount of polymerizable monomers) and, optionally, may contain at least one comonomer. Ethylene-based polymer includes ethylene homopolymer, and ethylene copolymer (meaning units derived from ethylene and one or more comonomers). The terms “ethylene-based polymer” and “polyethylene” may be used interchangeably.

An “interpolymer” is a polymer prepared by the polymerization of at least two different monomers. This generic term includes copolymers, usually employed to refer to polymers prepared from two different monomers, and polymers prepared from more than two different monomers, e.g., terpolymers, tetra polymers, etc.

An “olefin-based polymer” or “polyolefin” is a polymer that contains more than 50 weight percent polymerized olefin monomer (based on total amount of polymerizable monomers), and optionally, may contain at least one comonomer. Nonlimiting examples of an olefin-based polymer include ethylene-based polymer or propylene-based polymer.

A “polymer” is a compound prepared by polymerizing monomers, whether of the same or a different type, that in polymerized form provide the multiple and/or repeating “units” or “mer units” that make up a polymer. The generic term polymer thus embraces the term homopolymer, usually employed to refer to polymers prepared from only one type of monomer, and the term copolymer, usually employed to refer to polymers prepared from at least two types of monomers. It also embraces all forms of copolymer, e.g., random, block, etc. The terms “ethylene/α-olefin polymer” and “propylene/α-olefin polymer” are indicative of copolymer as described above prepared from polymerizing ethylene or propylene respectively and one or more additional, polymerizable α-olefin monomer. It is noted that although a polymer is often referred to as being “made of” one or more specified monomers, “based on” a specified monomer or monomer type, “containing” a specified monomer content, or the like, in this context the term “monomer” is understood to be referring to the polymerized remnant of the specified monomer and not to the unpolymerized species. In general, polymers herein are referred to has being based on “units” that are the polymerized form of a corresponding monomer.

### Test Methods

### ¹³C NMR

¹³C nuclear magnetic resonance (¹³C NMR) samples are prepared by adding approximately 2.7 g of a 50/50 (w:w) mixture of tetrachloroethane-d₂/orthodichlorobenzene containing 0.025 M chromium acetylacetonate, Cr(AcAc)₃ (or a tetrachloroethane-d₂ containing 0.025 M Cr(AcAc)₃) to 0.2 g polymer sample in a 10 mm NMR tube. Oxygen is removed from the sample by purging the tube headspace with nitrogen. The samples are then dissolved and homogenized by heating the tube and its contents to 135° C. using a heating block and a heat gun. Each dissolved sample is visually inspected to ensure homogeneity.

NMR data are collected using a 10 mm cryoprobe on either a Bruker 400 MHz or a 600 MHz spectrometer. The data is acquired using a 7.3 second pulse repetition delay, 90-degree flip angles, and inverse gated decoupling with a sample temperature of 120° C. All measurements are made with no sample spinning and in locked mode. Samples are allowed to thermally equilibrate for 7 minutes prior to data acquisition. The ¹³C NMR chemical shifts are internally referenced to the EEE triad at 30.0 ppm.

Comonomer content for ethylene and butene are determined using the assignments from reference (Sahoo et al., Macromolecules, 2003, 36, 4017) and integrated ¹³C NMR spectrum to solve the vector equation s=fM, where M is an assignment matrix, s is a row vector representation of the spectrum, and f is a mole fraction composition vector. The elements of f is taken to be triads of E (ethylene) and B (Butene) with all permutations of E and B. The assignment matrix M is created with one row for each triad in f and a column for each of the integrated NMR signals. The elements of the matrix are integral values determined by reference to the assignments (Sahoo et al., Macromolecules, 2003, 36, 4017). The equation is solved by variation of the elements of f as needed to minimize the error function between s and the integrated ¹³C data for each sample. This is performed in Microsoft Excel by using the Solver function.

¹³C NMR is also used to determine the degree of long chain branching (LCB) in the polymer. LCB was measured by first setting the integral of ¹³C NMR peaks from 8.0-45.0 ppm to 1000 carbons (1000C), then integrate the methine peak from 37.95 to 38.35 ppm. Assuming this integral is y, then LCB/1000C=y.

### ¹H NMR

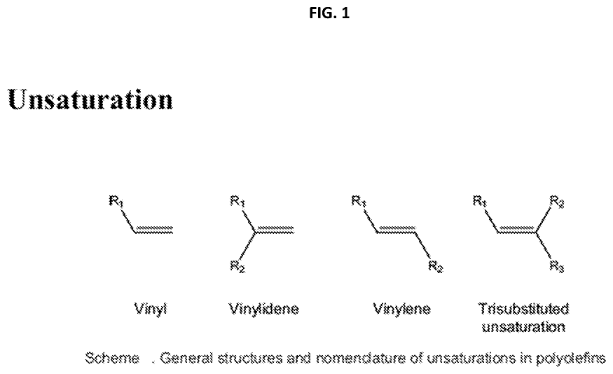

¹1-1 nuclear magnetic resonance CH NMR) detects the following types of carbon-carbon double bonds (“unsaturation”) in the polymer. “Vinylene” is a carbon-carbon double bond with the formula R₁— CH═CH— R₂, wherein R₁ and R₂ each is a carbon atom or a heteroatom selected from N, O, P, B, S, and Si. “Trisubstituted” is a carbon-carbon double bond in which the doubly bonded carbons are bonded to a total of three carbon atoms and wherein R₁, R₂ and R₃ (in FIG. 1) each is a carbon atom. “Vinyl” is a carbon-carbon double bond with the formula R— CH═CH₂, wherein R is a carbon atom or a heteroatom selected from N, O, P, B, S, and Si. “Vinylidene” is a carbon-carbon double bond with the formula C═CH₂. “Total unsaturation (or “total”) is the sum of vinylene, trisubstituted, vinyl, and vinylidene in a polymer. The chemical structures for vinylene, trisubstituted, vinyl, and vinylidene are provided in FIG. 1.

Polymer samples for ¹H NMR analysis were prepared by adding 130 mg of sample to 3.25 g of 50/50 by weight tetrachlorethane-d₂/perchloroethylene with 0.001 M Cr(AcAc)₃ in a 10 mm NMR tube. The samples were purged by bubbling N₂ through the solvent via a pipette inserted into the tube for approximately 5 minutes to prevent oxidation, capped, sealed with Teflon tape. The samples were heated and vortexed at 115° C. to ensure homogeneity.

¹H NMR was performed on a Bruker AVANCE 400/600 MHz spectrometer equipped with a Bruker high-temperature CryoProbe and a sample temperature of 120° C. Two experiments were run to obtain spectra, a control spectrum to quantify the total polymer protons, and a double presaturation experiment, which suppresses the intense polymer backbone peaks and enables high sensitivity spectra for quantitation of the end-groups. The control was run with ZG pulse, 4 scans, SWH 10,000 Hz, AQ 1.64s, D₁ 14s. The double presaturation experiment was run with a modified pulse sequence, Ic1prf2.zz1, TD 32768, 100 scans, DS 4, SWH 10,000 Hz, AQ 1.64s, D₁ 1s, D₁₃ 13s.

Density is measured in accordance with ASTM D792, Method B. The result is recorded in grams per cubic centimeter (g/cc).

### Differential Scanning Calorimetry (DSC)

Differential Scanning calorimetry (DSC) can be used to measure the melting, crystallization, and glass transition behavior of a polymer over a wide range of temperature. For example, the TA Instruments Discovery DSC, equipped with an RCS (refrigerated cooling system) and an autosampler is used to perform this analysis. During testing, a nitrogen purge gas flow of 50 ml/min is used. Each sample is melt pressed into a thin film at about 190° C.; the melted sample is then air-cooled to room temperature (about 25° C.). A 3-10 mg, 6 mm diameter specimen is extracted from the cooled polymer, weighed, placed in a light aluminum pan (ca 50 mg), and crimped shut. Analysis is then performed to determine its thermal properties.

The thermal behavior of the sample is determined by ramping the sample temperature up and down to create a heat flow versus temperature profile. First, the sample is rapidly heated to 180° C. and held isothermal for 5 minutes in order to remove its thermal history. Next, the sample is cooled to −90° C. at a 10° C./minute cooling rate and held isothermal at −90° C. for 5 minutes. The sample is then heated to 150° C. (this is the “second heat” ramp) at a 10° C./minute heating rate. The cooling and second heating curves are recorded.

The soft segment melting temperature, SS-Tm, is determined from the DSC second heating curve. Ethylene/octene multi-block copolymer (and ethylene/butene multi-block copolymer) typically has two melting peaks, one melting peak associated with each of the soft segment and hard segment. The SS-Tm is associated with the lower temperature peak. For some block copolymers, the peak associated with the melting of the soft segments is a small hump (or bump) over the baseline, making it difficult to assign a peak maximum. This difficulty can be overcome by converting a normal DSC profile into a weighted DSC profile using the following method. In DSC, the heat flow depends on the amount of the material melting at a certain temperature as well as on the temperature-dependent specific heat capacity. The temperature dependence of the specific heat capacity in the melting regime of linear low-density polyethylene leads to an increase in the heat of fusion with decreasing comonomer content. That is, the heat of fusion values get progressively lower as the crystallalinity is reduced with increasing comonomer content. See Wild, L. Chang, S.; Shankernarayanan, M J. Improved method for compositional analysis of polyolefins by DSC. Polym. Prep 1990; 31: 270-1, which is incorporated by reference herein in its entirety. For a given point in the DSC curve (defined by its heat flow in watts per gram and temperature in degrees Celsius), by taking the ratio of the heat of fusion expected for a linear copolymer to the temperature-dependent heat of fusion (ΔH (T)), the DSC curve can be converted into a weight-dependent distribution curve. The second heating curve is baseline corrected by drawing a linear baseline between the heat flow at −30 and 135° C. The temperature-dependent heat of fusion curve can then be calculated from the summation of the integrated heat flow between two consecutive data points and then represented overall by the cumulative enthalpy curve. The expected relationship between the heat of fusion for linear ethylene/octene copolymers at a given temperature is shown by the heat of fusion versus melting temperature curve. Using random ethylene/octene copolymers, one can obtain the following relationship for the expected heat of fusion of linear copolymers, ΔH_{linear copolymer}, and melting temperature, Tₘ (in ° C.):

ΔH_{linear copolymer}(J/g)=0.0072*Tₘ²+0.3138*Tₘ+8.9767

This relationship is applied to the ethylene/butene copolymers in this case. For each integrated data point, at a given temperature, by taking a ratio of the enthalpy from the cumulative enthalpy curve to the expected heat of fusion for linear copolymers at that temperature, fractional weights can be assigned to each point of the DSC curve. The method is applicable to ethylene/octene copolymers but can be adapted to other polymers, such as ethylene/butene copolymers in this present application. The SS-Tm is assigned as the location of the maximum in the enthalpy fractional weight versus temperature curve.

Glass transition temperature, Tg, is determined from the DSC second heating curve where half the sample has gained the liquid heat capacity as described in Bernhard Wunderlich, The Basis of Thermal Analysis, in Thermal Characterization of Polymeric Materials 92, 278-279 (Edith A. Turi ed., 2d ed. 1997). Baselines are drawn from below and above the glass transition region and extrapolated through the Tg region. The temperature at which the sample heat capacity is half-way between these baselines is the Tg.

Melting point, Tm, of the polymer is determined as the temperature corresponding to the maximum heat flow in the DSC heating curve.

### DMS Rheology

The rheology ratio (RR) (V0.1/V100) is determined by examining samples using melt rheology techniques on a Rheometric Scientific, Inc. ARES (Advanced Rheometric Expansion System) dynamic mechanical spectrometer (DMS). An Advanced Rheometric Expansion System (ARES) is equipped with 25 mm stainless steel parallel plates. Constant temperature dynamic frequency sweeps in the frequency range of 0.1 to 100 rad/s were performed under nitrogen purge at 190° C. Samples approximately 25.4 mm in diameter were cut from compression molded plaques. The sample was placed on the lower plate and allowed to melt for 5 min. The plates were then closed to a gap of 2.0 mm and the sample trimmed to 25 mm in diameter. The sample was allowed to equilibrate at 190° C. for 5 min before starting the test. The complex viscosity was measured at constant strain amplitude of 10%. V_{0.1} is the viscosity in Pascal-seconds (Pa-s) measured at 0.1 rad/s at 190° C. V100 is the viscosity in Pa-s measured at 100 rad/s at 190° C.

$$R R = Rheology Ratio = \frac{V 0.1}{V 100} at 190 ° C .$$

### Elastic Recovery

100% and 300% Hysteresis is determined from cyclic loading to 100% and 300% strains using ASTM D 1708 microtensile specimens with an Instron™ instrument. The sample is loaded and unloaded at 267% min⁻¹ for 3 cycles at 21° C. For a 300% strain cyclic experiment, the retractive stress at 150% strain from the first unloading cycle is recorded. For 100% strain cyclic experiment, the retractive stress at 50% strain from the first unloading cycle is recorded. Percent recovery for all experiments are calculated from the first unloading cycle using the strain at which the load returned to the base line. The percent elastic recovery is defined as:

$$\% Recovery = \frac{{ε}_{f} - {ε}_{s}}{{ε}_{f}} \times 100$$

where ε_{f} is the maximum strain used for cyclic loading and εₛ is the strain where the load returns to the baseline during the 1 ^{St} unloading cycle.

### Triple Detector GPC (TD-GPC)

The chromatographic system for the triple detector gel permeation chromatography (TD-GPC) consisted of a PolymerChar GPC-IR (Valencia, Spain) high temperature GPC chromatograph equipped with an internal IR5 infra-red detector (IR5). The autosampler oven compartment was set at 160° C. and the column compartment was set 150° C. The columns used were 4 Agilent “Mixed A” 30 cm 20-micron linear mixed-bed columns and a 20-um pre-column. The chromatographic solvent used was 1,2,4 trichlorobenzene and contained 200 ppm of butylated hydroxytoluene (BHT). The solvent source was nitrogen sparged. The injection volume used was 200 microliters and the flow rate was 1.0 milliliters/minute.

Calibration of the GPC column set was performed with 21 narrow molecular weight distribution polystyrene standards with molecular weights ranging from 580 to 8,400,000 and were arranged in 6 “cocktail” mixtures with at least a decade of separation between individual molecular weights. The standards were purchased from Agilent Technologies. The polystyrene standards were prepared at 0.025 grams in 50 milliliters of solvent for molecular weights equal to or greater than 1,000,000, and 0.05 grams in 50 milliliters of solvent for molecular weights less than 1,000,000. The polystyrene standards were dissolved at 80 degrees Celsius with gentle agitation for 30 minutes. The polystyrene standard peak molecular weights were converted to polyethylene molecular weights using Equation 1 (as described in Williams and Ward, J. Polym. Sci., Polym. Let., 6, 621 (1968)):

M_{polyethylene}=A×(M_{polystryene})^{B} (EQ1)

where M is the molecular weight, A has a value of 0.4315 and B is equal to 1.0

A fifth order polynomial was used to fit the respective polyethylene-equivalent calibration points. A small adjustment to A (from approximately 0.375 to 0.445) was made to correct for column resolution and band-broadening effects such that linear homopolymer polyethylene standard is obtained at 120,000 Mw.

The total plate count of the GPC column set was performed with decane (prepared at 0.04 g in 50 milliliters of TCB and dissolved for 20 minutes with gentle agitation.) The plate count (Equation 2) and symmetry (Equation 3) were measured on a 200 microliter injection according to the following equations:

$$Plate Count = 5.54 ⋆ {( \frac{{RV}_{Peak Max}}{Peak Width at 1 / 2 height} )}^{2} \qquad ( EQ2 )$$

where RV is the retention volume in milliliters and the peak width is in milliliters, Peak max is the maximum position of the peak, one tenth height is 1/10 height of the peak maximum, and where rear peak refers to the peak tail at later retention volumes than the peak max and where front peak refers to the peak front at earlier retention volumes than the peak max. The plate count for the chromatographic system should be greater than 18,000 and symmetry should be between 0.98 and 1.22.

Samples were prepared in a semi-automatic manner with the PolymerChar “Instrument Control” Software, wherein the samples were weight-targeted at 2 mg/ml, and the solvent (contained 200 ppm BHT) was added to a pre nitrogen-sparged septa-capped vial, via the PolymerChar high temperature autosampler. The samples were dissolved for 2 hours at 160° Celsius under “low speed” shaking.

The calculations of Mn(_{GPC}), Mw(_{GPC}), and MZ_{(GPC)} were based on GPC results using the internal IR5 detector (measurement channel) of the PolymerChar GPC-IR chromatograph according to Equations 4-6, using PolymerChar GPCOne™ software, the baseline-subtracted IR chromatogram at each equally-spaced data collection point (i), and the polyethylene equivalent molecular weight obtained from the narrow standard calibration curve for the point (i) from Equation 1.

$${Mn}_{( GPC )} = \frac{{\sum }^{i} {IR}_{i}}{{\sum }^{i} ( {IR}_{i} / {M}_{{polyethlene}_{i}} )} \qquad ( EQ4 )$$

$${Mn}_{( GPC )} = \frac{{\sum }^{i} {IR}_{i}}{{\sum }^{i} ( {IR}_{i} / {M}_{{polyethlene}_{i}} )} \qquad ( EQ5 )$$

$${Mz}_{( GPC )} = \frac{{\sum }^{i} ( {IR}_{i} ⋆ {M}_{{polyethylene}_{i}}^{2} )}{{\sum }^{i} ( {IR}_{i} ⋆ {M}_{{polyethlene}_{i}} )} \qquad ( EQ6 )$$

In order to monitor the deviations over time, a flowrate marker (decane) was introduced into each sample via a micropump controlled with the PolymerChar GPC-IR system. This flowrate marker (FM) was used to linearly correct the pump flowrate (Flowrate(nominal)) for each sample by RV alignment of the respective decane peak within the sample (RV(FM Sample)) to that of the decane peak within the narrow standards calibration (RV(FM Calibrated)). Any changes in the time of the decane marker peak are then assumed to be related to a linear-shift in flowrate (Flowrate(effective)) for the entire run. To facilitate the highest accuracy of a RV measurement of the flow marker peak, a least-squares fitting routine is used to fit the peak of the flow marker concentration chromatogram to a quadratic equation. The first derivative of the quadratic equation is then used to solve for the true peak position. After calibrating the system based on a flow marker peak, the effective flowrate (with respect to the narrow standards calibration) is calculated as Equation 7. Processing of the flow marker peak was done via the PolymerChar GPCOne™ Software. Acceptable flowrate correction is such that the effective flowrate should be within +/−1% of the nominal flowrate.

Flowrate(effective)=Flowrate(nominal)*(RV(FM Calibrated)/RV(FM Sample)) (EQ7)

Melt index (MI) (12) in g/10 min is measured in accordance with ASTM D₁₂₃₈ (190° C./2.16 kg).

### XRF

X-ray fluorescence (XRF) was performed using Spectro-Asoma (Marble Falls, Tex.) Phoenix energy dispersive XRF spectrometer. The spectrometer was equipped with a Mo anode X-ray tube, 30 kV power supply, Mo (2 mil thick) tube filter, an atmosphere neon sealed gas proportional detector with a 1 mil thick Be window, and version 220 of the operating software. The spectrometer was used to obtain Zn Kα characteristic x-ray intensities and x-ray tube backscattered intensities for samples and standards. The operating conditions used in the Phoenix method validation are listed in Table A below. The multi-block copolymer pellets were poured into XRF sample cups obtained from Chemplex Industries, INC. (catalog #1730) fit with polypropylene film (catalog #436). The cups were filled with pellets, but not overfilled so that pellets are above the top of the cup. The film was secured to the cup with the provided rings and the pellets tapped down on a flat surface covered with clean lint-free paper towel. The data was analyzed using a calibration developed based on ICP and XRF in Analytical Sciences. The reported Zn concentration values (in parts per million, “ppm”) were within +/−10%.

TABLE A

| | Tube Set-up: | Electronic Window | Count Time |
|---|---|---|---|
| Element | voltage, current | Low-High (keV) | (sec) |
| Zn | 25 kV, 60 mA | 7.0-9.14 | 100 |
| Mo-backscatter | 25 kV, 60 mA | 12.0-197.0 | 100 |

### DETAILED DESCRIPTION

The present disclosure provides a process. In an embodiment, a process is provided and includes contacting ethylene and butene under polymerization conditions at a temperature greater than 125° C. with a catalyst system. The catalyst system includes (i) a first polymerization catalyst and (ii) a second polymerization catalyst, and (iii) a chain shuttling agent. The first polymerization catalyst has the structure of Formula (III)

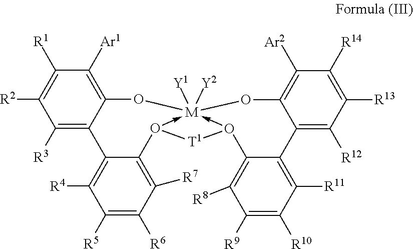

wherein

M is titanium, zirconium, or hafnium;

each Y¹ and Y² is independently selected from the group consisting of (C₁-C₄₀)hydrocarbyl, (C₁-C₄₀)trihydrocarbylsilylhydrocarbyl, halogen, alkoxide, or amine, or two Y groups together are a divalent hydrocarbylene, hydrocarbadiyl or trihydrocarbylsilyl group;

each Ar^{l} and Ar² independently is selected from the group consisting of (C₆- C₄₀)aryl, substituted (C₆-C₄₀)aryl, (C₃-C₄₀)heteroaryl, and substituted (C₃-C₄₀)heteroaryl;

T¹ independently at each occurrence is a saturated C₂-C₄ alkyl that forms a bridge between the two oxygen atoms to which T¹ is bonded; and each R¹, R², R³, R⁴, R⁵, R⁶, R⁷, R⁸, R⁹, R¹⁰, R¹¹, R¹², R¹³, and R¹⁴ independently is selected from the group consisting of hydrogen, a halogen, (C₁-C₄₀)hydrocarbyl, substituted (C₁-C₄₀)hydrocarbyl, (C₁-C₄₀)heterohydrocarbyl, substituted (C₁-C₄₀)heterohydrocarbyl, (C₆-C₄₀)aryl, substituted (C₆-C₄₀)aryl, (C₃-C₄₀)heteroaryl, and substituted (C₃-C₄₀)heteroaryl, and nitro (NO₂).

The second polymerization catalyst (ii) has the structure of Formula (I)

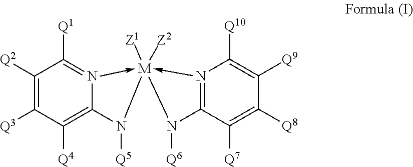

wherein

M is titanium, zirconium, or hafnium,

each Z¹ and Z² is independently selected from the group consisting of (C₁-C₄₀)hydrocarbyl, (C₁-C₄₀)trihydrocarbylsilylhydrocarbyl, halogen, alkoxide, or amine, or two Z groups together are a divalent hydrocarbylene, hydrocarbadiyl or trihydrocarbylsilyl group;

each Q¹ and Q¹⁰ independently is selected from the group consisting of (C₆-C₄₀)aryl, substituted (C₆-C₄₀)aryl, (C₃-C₄₀)heteroaryl, and substituted (C₃-C₄₀)heteroaryl;

each Q², Q³, Q⁴, Q⁷, Q⁸ and Q⁹ independently is selected from the group consisting of hydrogen, (C₁-C₄₀)hydrocarbyl, substituted (Cr C₄₀)hydrocarbyl, (C₁-C₄₀)heterohydrocarbyl, substituted (Cr C₄₀)heterohydrocarbyl, halogen, and nitro (NO₂);

each Q⁵ and Q⁶ independently is selected from the group consisting of (C₁-C₄₀)alkyl, substituted (C₁-C₄₀)alkyl, and [(Si)₁—(C+Si)₄₀] substituted organosilyl;

each N independently is nitrogen;

optionally, two or more of the Q¹⁻⁵ groups combine together to form a ring structure, with such ring structure having from 5 to 16 atoms in the ring excluding any hydrogen atoms; and optionally, two or more of the Q⁶⁻¹⁰ groups can combine together to form a ring structure, with such ring structure having from 5 to 16 atoms in the ring excluding any hydrogen atoms.

The catalyst system also includes the chain shuttling agent (iii). The process includes forming an ethylene/butene multi-block copolymer having an LCB/1000C greater than, or equal to, 0.06.

The process includes contacting ethylene and butene under polymerization conditions at a temperature greater than 125° C. with a catalyst system. The term “polymerization conditions,” as used herein refers to process parameters under which ethylene and butene are copolymerized in the presence of a catalyst system. Polymerization conditions include, for example, polymerization reactor conditions (reactor type), reactor pressure, reactor temperature, concentrations of reagents and polymer, solvent, carrier, residence time and distribution, influencing the molecular weight distribution and polymer structure. The term polymerization conditions, as used herein, includes a polymerization temperature greater 125° C.

In an embodiment, the polymerization conditions includes a polymerization temperature from 130° C. to 170° C., or from 130° C. to 160° C., or from 140° C. to 150° C.

The process includes contacting ethylene and butene under polymerization conditions at a temperature greater than 125° C. with a catalyst system. The catalyst system includes (i) a first polymerization catalyst (Formula (III) above), (ii) a second polymerization catalyst (Formula (I) above), and (iii) a chain shuttling agent. The catalyst system includes a chain shuttling agent. A “chain shuttling agent,” as used herein, refers to a compound that is capable of causing polymeryl transfer between various active catalyst sites under the polymerization conditions. That is, transfer of a polymer fragment occurs both to and from an active catalyst site in a facile and reversible manner. In contrast to a shuttling agent or chain shuttling agent, an agent that acts merely as a “chain transfer agent,” such as some main-group alkyl compounds, may exchange, for example, an alkyl group on the chain transfer agent with the growing polymer chain on the catalyst, which generally results in termination of the polymer chain growth. In this event, the main-group center may act as a repository for a dead polymer chain, rather than engaging in reversible transfer with a catalyst site in the manner in which a chain shuttling agent does. Desirably, the intermediate formed between the chain shuttling agent and the polymeryl chain is not sufficiently stable relative to exchange between this intermediate and any other growing polymeryl chain, such that chain termination is relatively rare.

The process includes forming an ethylene/butene multi-block copolymer having a LCB/1000C greater than or equal to 0.06. The term “ethylene/butene multi-block copolymer” is a copolymer consisting of ethylene and butene comonomer in polymerized form, the polymer characterized by multiple blocks or segments of two polymerized monomer units (i.e., ethylene and butene) differing in chemical or physical properties, the blocks joined (or covalently bonded) in a linear manner, that is, a polymer comprising chemically differentiated units which are joined end-to-end with respect to polymerized ethylenic functionality. The ethylene/butene multi-block copolymer includes block copolymer with two blocks (di-block) and more than two blocks (multi-block). The ethylene/butene multi-block copolymer is void of, or otherwise excludes, styrene (i.e., is styrene-free), and/or vinyl aromatic monomer, and/or conjugated diene. When referring to amounts of “ethylene” or “butene,” or “comonomer” in the copolymer, it is understood that this refers to polymerized units thereof. The ethylene/butene multi-block copolymer can be represented by the following formula: (AB)n; where n is at least 1, preferably an integer greater than 1, such as 2, 3, 4, 5, 10, 15, 20, 30, 40, 50, 60, 70, 80, 90, 100, or higher, “A” represents a hard block or segment, and “B” represents a soft block or segment. The As and Bs are linked, or covalently bonded, in a substantially linear fashion, or in a linear manner, as opposed to a substantially branched or substantially star-shaped fashion. In other embodiments, A blocks and B blocks are randomly distributed along the polymer chain. In other words, the block copolymers usually do not have a structure as follows: AAA-AA-BBB-BB. In an embodiment, the ethylene/butene multi-block copolymer does not have a third type of block, which comprises different comonomer(s). In another embodiment, each of block A and block B has monomers or comonomers substantially randomly distributed within the block. In other words, neither block A nor block B comprises two or more sub-segments (or sub-blocks) of distinct composition, such as a tip segment, which has a substantially different composition than the rest of the block.

Ethylene comprises the majority mole fraction of the whole ethylene/butene multi-block copolymer. Ethylene comprises at least 50 mole % (mol %) of the whole ethylene/butene multi-block copolymer. In an embodiment, the ethylene/butene multi-block copolymer contains from 50 mol %, or 60 mol %, or 65 mol % to 80 mol %, or 85 mol %, or 90 mol %, or 95 mol % ethylene and a reciprocal amount of butene, or from 5 mol %, or 10 mol %, or 15 mol %, or 20 mol % to 35 mol %, or 40 mol %, or less than 50 mol % butene based on the total moles of the ethylene/butene multi-block copolymer. In a further embodiment, the ethylene/butene multi-block copolymer contains from 5 mol % to 30 mol % butene (and from 95 mol % to 70 mol % ethylene), or from 10 mol % to 25 mol % butene (and from 90 mol % to 75 mol % ethylene).

The ethylene/butene multi-block copolymer includes various amounts of “hard” segments and “soft” segments. “Hard” segments are blocks of polymerized units in which ethylene is present in an amount greater than 90 wt %, or 95 wt %, or greater than 95 wt %, or greater than 98 wt %, based on the weight of the polymer, up to 100 wt %. In other words, the comonomer content (content of monomers other than ethylene) in the hard segments is less than 10 wt %, or 5 wt %, or less than 5 wt %, or less than 2 wt %, based on the weight of the polymer, and can be as low as zero. In some embodiments, the hard segments include all, or substantially all, units derived from ethylene. “Soft” segments are blocks of polymerized units in which the comonomer content (content of butene) is greater than 5 wt %, or greater than 8 wt %, or greater than 10 wt %, or greater than 15 wt %, based on the weight of the polymer. In an embodiment, the comonomer content in the soft segments is greater than 20 wt %, or greater than 25 wt %, or greater than 30 wt %, or greater than 35 wt %, or greater than 40 wt %, or greater than 45 wt %, or greater than 50 wt %, or greater than 60 wt % and can be up to 100 wt %.

The soft segments can be present in the ethylene/butene multi-block copolymer from 1 wt %, or 5 wt %, or 10 wt %, or 15 wt %, or 20 wt %, or 25 wt %, or 30 wt %, or 35 wt %, or 40 wt %, or 45 wt % to 55 wt %, or 60 wt %, or 65 wt %, or 70 wt %, or 75 wt %, or 80 wt %, or 85 wt %, or 90 wt %, or 95 wt %, or 99 wt % of the total weight of the ethylene/butene multi-block copolymer. Conversely, the hard segments can be present in similar ranges. The soft segment weight percentage and the hard segment weight percentage can be calculated based on data obtained from DSC or NMR. Such methods and calculations are disclosed in, for example, U.S. Pat. No. 7,608,668, the disclosure of which is incorporated by reference herein in its entirety. In particular, hard and soft segment weight percentages and soft-segment melting temperature (SS-Tm) may be determined as described in column 57 to column 63 of U.S. Pat. No. 7,608,668.

The ethylene/butene multi-block copolymer comprises two or more chemically distinct regions or segments (referred to as “blocks”) joined (or covalently bonded) in a linear manner, that is, it contains chemically differentiated units which are joined end-to-end with respect to polymerized ethylenic functionality, rather than in pendent or grafted fashion. The blocks differ in the amount or type of incorporated comonomer, density, amount of crystallinity, crystallite size attributable to a polymer of such composition, type or degree of tacticity (isotactic or syndiotactic), regio-regularity or regio-irregularity, amount of branching (including long chain branching or hyper-branching), homogeneity or any other chemical or physical property. Compared to block interpolymers of the prior art, including interpolymers produced by sequential monomer addition, fluxional catalysts, or anionic polymerization techniques, the present ethylene/butene multi-block copolymer is characterized by unique distributions of both polymer polydispersity (PDI or Mw/Mn or MWD), polydisperse block length distribution, and/or polydisperse block number distribution, due, in an embodiment, to the effect of the shuttling agent(s) in combination with multiple catalysts used in their preparation.

In an embodiment, the ethylene/butene multi-block copolymer is produced in a continuous process and possesses a polydispersity index (Mw/Mn) from 1.7 to 3.5, or from 1.8 to 3, or from 1.8 to 2.5, or from 1.8 to 2.2. When produced in a batch or semi-batch process, the ethylene/butene multi-block copolymer possesses Mw/Mn from 1.0 to 3.5, or from 1.3 to 3, or from 1.4 to 2.5, or from 1.4 to 2.

In addition, the ethylene/butene multi-block copolymer possesses a PDI (or Mw/Mn) fitting a Schultz-Flory distribution rather than a Poisson distribution. The present ethylene/butene multi-block copolymer has both a polydisperse block distribution as well as a polydisperse distribution of block sizes. This results in the formation of polymer products having improved and distinguishable physical properties. The theoretical benefits of a polydisperse block distribution have been previously modeled and discussed in Potemkin, Physical Review E (1998) 57 (6), pp. 6902-6912, and Dobrynin, J. Chem. Phvs. (1997) 107 (21), pp. 9234-9238.

In an embodiment, the present ethylene/butene multi-block copolymer possesses a most probable distribution of block lengths.

The process forms an ethylene/butene multi-block copolymer having a long chain branching (LCB) greater than or equal to 0.04, or greater than or equal to 0.06 long chain branches per 1000 carbons, or 0.06 LCB/1000C. Long chain branching per 1000 carbons, or “LCB/1000C,” is a ratio of how many long chain branches (carbon chains with greater than 6 carbons per 1000 carbons) in a polyolefin molecule. In other words, LCB/1000C is a measurement of the number of carbon chains exceeding 6 carbons in length that are incorporated in the polymer chain. A polymer with a larger LCB/1000C value has more long chain branches along the polymer backbone compared to a polymer with a smaller LCB/1000C value. All other polymer properties being equal, a larger LCB/1000C value typically results in greater shear thinning viscosity.

In an embodiment, the process includes forming an ethylene/butene multi-block copolymer having a LCB/1000C content from 0.04 to 0.80, or from 0.05 to 0.20, or from 0.06 to 0.15.

In an embodiment, the process includes contacting ethylene and butene under polymerization conditions at a temperature from 130° C. to 170° with a catalyst system. The catalyst system includes

(i) a first polymerization catalyst that is hafnium, [[2′,2′″-[1,4-butanediylbis(oxy-_{K}O)]bis[3-(9H-carbazol-9-yl)-5-methyl-5′-fluoro[1,1′-biphenyl]-2-olato-_{K}O]](2-)]dimethyl-, and has a structure of catalyst 1

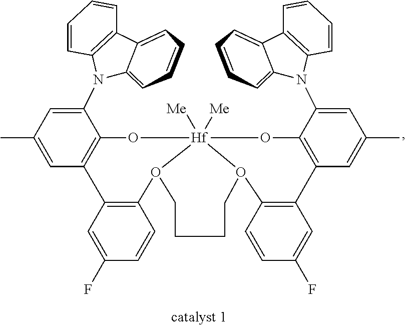

(ii) a second polymerization catalyst that is hafnium, dimethylbis[N-(2-methylpropyl)-6-(2,4,6-trimethylphenyl)-2-pyridinaminato-_{K}N1, _{K}N2]-, and has a structure of catalyst 2

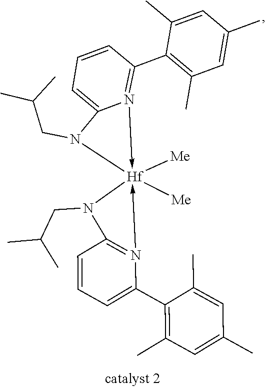

and

(iii) a chain shuttling agent that is diethyl zinc. The process includes forming an ethylene/butene multi-block copolymer having a rheology ratio (RR) and a viscosity at 0.1 radians per second (V_{0.1}) wherein RR fulfills Equation (A):

RR≥[(−3.0×10⁻⁸×(V_{0.1})²]+[0.001×(V_{0.1})]+0.85. Equation (A)

In an embodiment, the process includes forming an ethylene/butene multi-block copolymer that fulfills Equation (A) above and the ethylene/butene multi-block copolymer also has a viscosity at 100 rad/s (V₁₀₀) wherein RR fulfills Equation (B):

RR≥[(2.0×10⁻⁶)×(V₁₀₀)²]+[0.003×(V₁₀₀)]+0.6. Equation (B)

The present disclosure provides a composition formed from the previously-described polymerization process. In an embodiment, the composition includes an ethylene/butene multi-block copolymer having a LCB/1000C greater than or equal to 0.04, or greater than or equal to 0.06.

In an embodiment, the composition includes an ethylene/butene multi-block copolymer having a LCB/1000C content from 0.04 LCB/1000C to 0.80 LCB/1000C, or from 0.05 LCB/1000C to 0.20 LCB/1000C, or from 0.06 LCB/1000C to 0.15 LCB/1000C.

In an embodiment, the ethylene/butene multi-block copolymer of the composition includes from 10 mol % to 30 mol % of butene and a reciprocal amount of ethylene or from 90 mol % to 70 mol % ethylene, based on total moles of the ethylene/butene multi-block copolymer.

In an embodiment, the ethylene/butene multi-block copolymer of the composition has a rheology ratio (RR) and a viscosity at 0.1 radians per second (V_{0.1}) wherein RR fulfills Equation (A):

RR≥[(−3.0×10⁻⁸)×(V_{0.1})²]+[0.001×(V_{0.1})]+0.85. Equation (A)

In an embodiment, the ethylene/butene multi-block copolymer of the composition fulfills Equation (A) above and the ethylene/butene multi-block copolymer also has a viscosity at 100 rad/s (V₁₀₀) wherein RR fulfills Equation (B):

RR≥[(2.0×10⁻⁶)×(V₁₀₀)²]+[0.003×(V₁₀₀)]+0.6. Equation (B)

In an embodiment, the ethylene/butene multi-block copolymer of the composition has a rheology ratio (RR) from 1.2 to 10.0. In a further embodiment, the ethylene/butene multi-block copolymer has a RR from 1.2 to 8.0 and the RR fulfills Equation (A) and fulfills Equation (B).

In an embodiment, the ethylene/butene multi-block copolymer of the composition has hard segments and soft segments, the soft segments having a soft segment melting temperature (SS-Tm) from −5° C. to 35° C., or from −5° C. to 33° C., or from −5° C. to 30° C.

In an embodiment, the ethylene/butene multi-block copolymer of the composition has a glass transition temperature (Tg) from −50° C.-to −70° C., or from −52° C. to −66° C.

In an embodiment, the ethylene/butene multi-block copolymer of the composition has a density from 0.860 g/cc to 0.890 g/cc, or from 0.865 g/cc to 0.885 g/cc.

In an embodiment, the ethylene/butene multi-block copolymer of the composition has a Tm from −105° C. to 122° C.; or from 109° C. to 120° C.

In an embodiment, the ethylene/butene copolymer of the composition has a melt index (12) from 0.1 g/10 min to 40.0 g/10 min, or from 0.5 g/10 min to 20 g/10 min, or from 1.0 to 10 g/10 min, or from 1.0 g/10 min to 5 g/10 min.

In an embodiment, the ethylene/butene multi-block copolymer of the composition has an elastic recovery (Re) from 50%, or 60% to 70%, or 80%, or 90%, at 300% min⁻¹ deformation rate at 21° C. as measured in accordance with ASTM D1708.

In an embodiment, the ethylene/butene multi-block copolymer of the composition has a polydisperse distribution of blocks and a polydisperse distribution of block sizes;

In an embodiment, the ethylene/butene multi-block copolymer of the composition has one, some, or all of the following properties:
(i) a LCB/1000C content from 0.05 to 0.20, or from 0.06 to 0.15; and/or
(ii) from 10 mol % to 30 mol % butene; and/or
(iii) a rheology ratio (RR) from 1.2 to 8.0; and/or
(iv) a V_{0.1} wherein RR≥(−3.0×10⁻⁸)×(V_{0.1})²+0.001×(V_{0.1})+0.85; and/or
(v) a V₁₀₀ wherein RR≥(2.0×10⁻⁶)×(V₁₀₀)²+0.003×(V₁₀₀)+0.6; and/or
(vi) a SS-Tm from −5° C. to 35° C., or from −5° C. to 33° C., or from −5° C. to 30° C.; and/or

(vii) a Tg from −50° C. to −70° C.; and/or

(viii) a density from 0.860 g/cc to 0.890 g/cc; and/or

(ix) a Tm from 105° C. to 122° C.; and/or

(x) a melt index (I2) from 0.1 g/10 min to 40.0 g/10 min, or from 0.5 g/10 min to 20 g/10 min; and/or

(xi) an elastic recovery (Re) from 50% to 90%; and/or

(xii) a Mw/Mn from 1.7 to 3.5; and/or
(xiii) a polydisperse distribution of blocks and a polydisperse distribution of block sizes.

By way of example, and not limitation, some embodiments of the present disclosure are described in detail in the following examples.

### Examples

Table 1 below provides catalysts, co-catalysts, and chain shuttling agent used to prepare Comparative Samples (CS) A-C and Inventive Examples (1E) 1-5.

TABLE 1
Materials

| | |
|---|---|
| 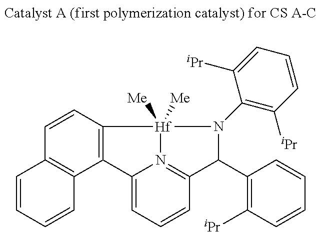 | Hafnium, [N-[2,6-bis(1-methylethyl)phenyl]-α-[2-(1- methylethyl)phenyl]-6-(1-naphthalenyl-kC2)-2- pyridinemethanaminato(2)-kN1, kN2]dimethyl- |
| 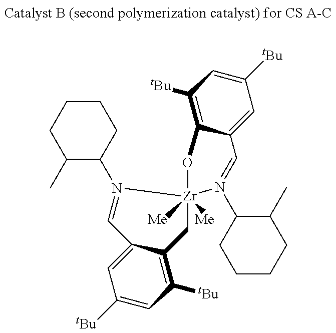 | Zirconium, bis[2,4-bis(1,1-dimethylethyl)-6-[[(2- methylcyclohexyl)imino-kN]methyl]phenolato-kO]dimethyl- |
| 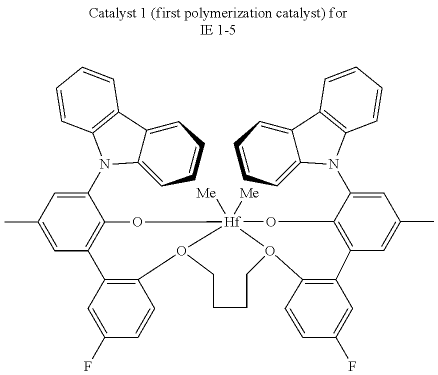 | Hafnium, [[2′,2′′′-(1,4-butanediylbis(oxy-kO)]bis[3-(9H-carbazol-9- yl)-5-methyl-5′-fluoro[1,1′-biphenyl]-2-olato-kO]](2-)]dimethyl- |
| 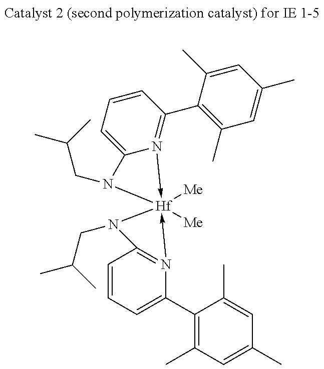 | Hafnium, dimethylbis[N-(2-methylpropyl)-6-(2,4,6- trimethylphenyl)-2-pyridinaminato-kN1, kN2]- |
| Cocatalyst 3 - all samples | A mixture of methyldi(C₁₄₋₁₈alkyl)ammonium salts of tetrakis- |
| | (pentafluorophenyl)borate, prepared by reaction of a long chain |
| | trialkylamine (ARMEEN M2HT, available from Akzo-Nobel, Inc.), |
| | HCl and Li[B(C₆F₅)₄], cocatalyst 3 available from Boulder Scientific |
| Cocatalyst 4 - all samples | iso-butyl, methyl, branched, cyclic and linear modified methyl |
| | aluminosiloxane (MMAO), available from AkzoNobel |
| Chain Shuttling Agent - all samples | diethylzinc |

### Polymerization of CS A-C and IE 1-5

All raw materials (monomer and comonomer) and the process solvent (a narrow boiling range high-purity isoparaffinic solvent, Isopar-E) are purified with molecular sieves before introduction into the reaction environment. Hydrogen is supplied pressurized as a high purity grade and is not further purified. The reactor monomer feed stream is pressurized via a mechanical compressor to above reaction pressure. The solvent and comonomer feed is pressurized via a pump to above reaction pressure. The individual catalyst components are manually batch diluted with purified solvent and pressurized to above reaction pressure. All reaction feed flows are measured with mass flow meters and independently controlled with computer automated control systems.

The polymerization occurs in a well-mixed, continuous solution reactor. Independent control is provided for all fresh solvent, monomer, comonomer, hydrogen, and catalyst component feeds is possible. The total fresh feed stream to the reactor (solvent, monomer, comonomer, and hydrogen) is temperature controlled to maintain a single solution phase by passing the feed stream through a heat exchanger. The total fresh feed to the polymerization reactor is injected into the reactor. The catalysts, co-catalysts, and chain shuttling agent are injected into the reactor through specially designed injection stingers. The first polymerization catalyst component feed is computer controlled to maintain the reactor monomer conversion at the specified target. The molar ratio of the second polymerization catalyst feed to total catalyst feed is adjusted to maintain the desired split between the polymer soft segment and polymer hard segment. The co-catalyst components are fed based on calculated specified molar ratios to the catalyst components.

The reactor effluent enters a zone where it is deactivated with the addition of, and reaction with, a suitable reagent (water). At this same reactor exit location other additives are added for polymer stabilization. Following catalyst deactivation and additive addition, the reactor effluent enters a devolatization system where the polymer is removed from the non-polymer stream. The isolated polymer melt is pelletized and collected.

The reactor stream feed data flows that correspond to the values in Table 2 are used to produce the comparative samples and inventive examples.

Polymerization conditions for comparative samples (CS) CS A-C and inventive examples (1E) IE 1-5 are provided in Table 2 below.

TABLE 2
Polymerization conditions for CS A-C and IE 1-5

| | | CS A | CS B | CS C | IE 1 | IE 2 | IE 3 | IE 4 | IE 5 |
|---|---|---|---|---|---|---|---|---|---|
| Reactor Configuration | Type | Single | Single | Single | Single | Single | Single | Single | Single |
| Comonomer type | Type | butene | butene | butene | butene | butene | butene | butene | butene |
| Reactor Feed Solvent/ | g/g | 10.9 | 10.9 | 12.1 | 12.2 | 12.2 | 12.3 | 12.3 | 13.4 |
| Ethylene Mass Flow | | | | | | | | | |
| Ratio | | | | | | | | | |
| Reactor Feed | g/g | 0.72 | 1.08 | 1.46 | 0.97 | 0.97 | 2.20 | 1.74 | 1.70 |
| Comonomer/Ethylene | | | | | | | | | |
| Mass Flow Ratio | | | | | | | | | |
| Reactor Feed Hydrogen/ | g/g | 1.6E−04 | 8.8E−05 | 1.5E−05 | 1.4E−05 | 4.6E−04 | 0.0E+00 | 0.0E+00 | 1.6E−05 |
| Ethylene Mass Flow | | | | | | | | | |
| Ratio | | | | | | | | | |
| Reactor Zn/Ethylene | g/g | 1.52E−04 | 1.72E−04 | 2.38E−04 | 5.40E−04 | 9.92E−04 | 2.75E−04 | 2.75E−04 | 1.94E−04 |
| Mass Flow Ratio | | | | | | | | | |
| Reactor Temperature | ° c. | 120 | 120 | 120 | 150 | 150 | 150 | 150 | 150 |
| Reactor Pressure | barg | 43 | 43 | 43 | 43 | 43 | 43 | 43 | 43 |
| Reactor Ethylene | wt % | 86.6 | 86.1 | 85.6 | 81.2 | 81.5 | 76.2 | 78.2 | 78.0 |
| Conversion | | | | | | | | | |
| % of Total Catalyst Feed | Mole | 11.1 | 12.1 | 39.5 | 67.5 | 81.0 | 68.9 | 70.0 | 61.3 |
| from Catalyst 2 | % | | | | | | | | |
| Co-Catalyst 1 to Total | Ratio | 1.2 | 1.2 | 1.2 | 1.2 | 1.2 | 1.2 | 1.2 | 1.2 |
| Catalyst Molar Ratio (B | | | | | | | | | |
| to Metal) | | | | | | | | | |
| Co-Catalyst 2 Scavenger | Ratio | 10.3 | 10.3 | 16.3 | 10.0 | 10.0 | 10.0 | 10.1 | 10.0 |
| Molar Ratio (Al to Metal) | | | | | | | | | |
| Reactor Residence Time | min | 13.2 | 13.1 | 14.8 | 12.4 | 12.3 | 14.0 | 14.1 | 13.1 |

The properties of CS A-C and IE 1-5 produced in Table 2 are shown in Table 3 below.

TABLE 3
Properties of ethylene/butene multi-block copolymers

| | | | | | | | NMR | | | | | | | | | |
|---|---|---|---|---|---|---|---|---|---|---|---|---|---|---|---|---|
| | | | | SS | | Mw/ | C4 | LCB/ | V0.1, | V100, | | | 3- | | | |
| sample | I2 | d | Zn | Tₘ, ° C. | Mw | Mn | mol % | 1000 C. | Pa-s | Pa-s | RR | vinylene | sub | vinyl | vinylidene | Total |
| CS A | 0.99 | 0.880 | 92 | 32.2 | 105937 | 2.84 | 12.7 | ND | 11699 | 1393 | 8.4 | 39 | 8 | 32 | 73 | 151 |
| CS B | 1.22 | 0.867 | 102 | 6.7 | 112924 | 2.79 | 18.5 | ND | 8293 | 1296 | 6.4 | 34 | 9 | 31 | 93 | 167 |
| CS C | 1.26 | 0.879 | 152 | 12.0 | 125871 | 3.50 | 20.1 | ND | 8594 | 1212 | 7.1 | 49 | 5 | 31 | 118 | 203 |
| IE 1 | 1.26 | 0.877 | 397 | 32.8 | 100956 | 2.53 | 14.3 | 0.08 | 9113 | 1206 | 7.6 | 32 | 3 | 37 | 69 | 141 |
| IE 2 | 37.2 | 0.879 | 604 | 28.3 | 46890 | 2.21 | 14.3 | 0.12 | 214 | 153 | 1.4 | 36 | 5 | 44 | 73 | 158 |
| IE 3 | 2.59 | 0.878 | 158 | 23.3 | 106336 | 2.33 | 21.6 | 0.06 | 4007 | 842 | 4.8 | 44 | 6 | 42 | 141 | 232 |
| IE 4 | 1.22 | 0.880 | 178 | −3.7 | 122896 | 2.43 | 18.6 | NM | 8694 | 1166 | 7.5 | 38 | 4 | 41 | 112 | 195 |
| IE 5 | 1.52 | 0.870 | 158 | 2.6 | 114602 | 2.84 | 20.7 | 0.06 | 7148 | 1001 | 7.1 | 46 | 6 | 43 | 133 | 228 |

d = density, g/cc
I2 = melt index, g/10 min, 190° C.
Mw—g/mol
RR = Rheology Ratio, RR = V0.1/V100 (190° C.)
Zn = ppm Zn measured by XRF
3-sub = trisubstituted
Total = sum of vinylene, 3-sub, vinyl, and vinylidene
Vinylene, 3-sub, vinyl, vinylidene, and Total reported as #/1,000,000 carbons

Ethylene/butene multi-block block copolymer is produced with two different pairs of catalysts. Catalyst A and Catalyst B were utilized to produce comparative samples A-C. As shown in Table 3, no, or substantially no, long chain branching is detectable in CS A-CS C using ¹³C NMR. However, when Catalyst 1 and Catalyst 2 were utilized to produce Inventive Examples 1-5 under similar process conditions (except at increased reactor temperature), ¹³C NMR detects long chain branching in the ethylene/butene multi-block copolymer ranging from 0.06 LCB/1000C to 0.12 LCB/1000C.

It is specifically intended that the present disclosure not be limited to the embodiments and illustrations contained herein, but include modified forms of those embodiments including portions of the embodiments and combinations of elements of different embodiments as come within the scope of the following claims.

1. A process comprising:
contacting ethylene and butene under polymerization conditions at a temperature greater than 125° C. with a catalyst system comprising
(i) a first polymerization catalyst having the structure of Formula (III) 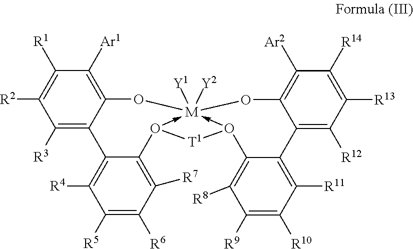
wherein
M is titanium, zirconium, or hafnium;
each Y¹ and Y² is independently selected from the group consisting of (C₁-C₄₀)hydrocarbyl, (C₁-C₄₀)trihydrocarbylsilylhydrocarbyl, halogen, alkoxide, or amine, or two Y groups together are a divalent hydrocarbylene, hydrocarbadiyl or trihydrocarbylsilyl group;
each Ar¹ and Ar² independently is selected from the group consisting of (C₆- C₄₀)aryl, substituted (C₆-C₄₀)aryl, (C₃-C₄₀)heteroaryl, and substituted (C₃-C₄₀)heteroaryl;
T¹ independently at each occurrence is a saturated C₂-C₄ alkyl that forms a bridge between the two oxygen atoms to which T¹ is bonded; and
each R¹, R², R³, R⁴, R⁵, R⁶, R⁷, R⁸, R⁹, R¹⁰, R¹¹, R¹², R¹³, and R¹⁴ independently is selected from the group consisting of hydrogen, a halogen, (C₁-C₄₀)hydrocarbyl, substituted (C₁-C₄₀)hydrocarbyl, (C₁-C₄₀)heterohydrocarbyl, substituted (C₁-C₄₀)heterohydrocarbyl, (C₆-C₄₀)aryl, substituted (C₆-C₄₀)aryl, (C₃-C₄₀)heteroaryl, and substituted (C₃-C₄₀)heteroaryl, and nitro (NO₂);
(ii) a second polymerization catalyst having the structure of Formula (I) 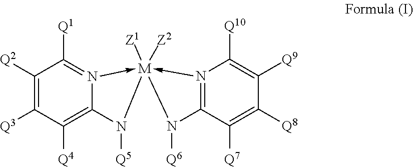
wherein
M is titanium, zirconium, or hafnium,
each Z¹ and Z² is independently selected from the group consisting of (C₁-C₄₀)hydrocarbyl, (C₁-C₄₀)trihydrocarbylsilylhydrocarbyl, halogen, alkoxide, or amine, or two Z groups together are a divalent hydrocarbylene, hydrocarbadiyl or trihydrocarbylsilyl group;
each Q¹ and Q¹⁰ independently is selected from the group consisting of (C₆-C₄₀)aryl, substituted (C₆-C₄₀)aryl, (C₃-C₄₀)heteroaryl, and substituted (C₃-C₄₀)heteroaryl;
each Q², Q³, Q⁴, Q², Q⁸ and Q⁹ independently is selected from the group consisting of hydrogen, (C₁-C₄₀)hydrocarbyl, substituted (Cr C₄₀)hydrocarbyl, (C₁-C₄₀)heterohydrocarbyl, substituted (Cᵣ C₄₀)heterohydrocarbyl, halogen, and nitro (NO₂);
each Q⁵ and Q⁶ independently is selected from the group consisting of (C₁-C₄₀)alkyl, substituted (C₁-C₄₀)alkyl, and [(Si)₁-(C+Si)₄₀] substituted organosilyl;
each N independently is nitrogen;
optionally, two or more of the Q¹⁻⁵ groups combine together to form a ring structure, with such ring structure having from 5 to 16 atoms in the ring excluding any hydrogen atoms; and
optionally, two or more of the Q⁶⁻¹⁰ groups can combine together to form a ring structure, with such ring structure having from 5 to 16 atoms in the ring excluding any hydrogen atoms; and
optionally, two or more of the Q⁶⁻¹⁰ groups can combine together to form a ring structure, with such ring structure having from 5 to 16 atoms in the ring excluding any hydrogen atoms;
(iii) a chain shuttling agent; and
forming an ethylene/butene multi-block copolymer having LCB/1000C greater than or equal to 0.06.

2. The process of claim 1 comprising contacting the ethylene and butene under polymerization conditions at a temperature from 130° C. to 170° C. with a catalyst system comprising
(i) a first polymerization catalyst having a structure of catalyst 1 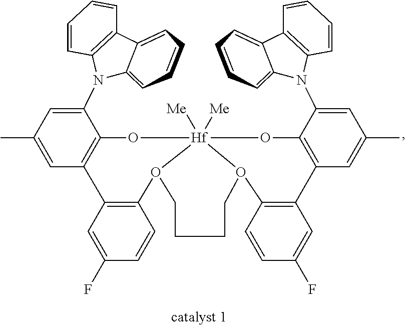
(ii) a second polymerization catalyst having a structure of catalyst 2 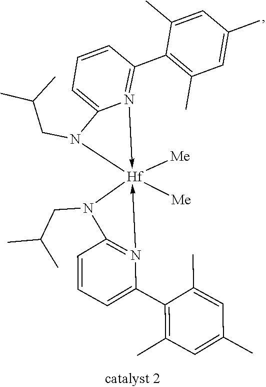
and
(iii) a chain shuttling agent that is diethyl zinc; and
forming an ethylene/butene multi-block copolymer having a rheology ratio (RR) and a viscosity at 0.1 radians per second (V_{0.1}) wherein RR fulfills Equation (A)
RR≥[(−3.0×10⁻⁸)×(V_{0.1})²]+[0.001×(V_{0.1})]+0.85. Equation (A)

3. The process of claim 2, comprising forming an ethylene/butene multi-block copolymer having a viscosity at 100 rad/s (V₁₀₀) wherein RR fulfills Equation (B)
RR≥[(2.0×10⁻⁶)×(V₁₀₀)²]+[0.003×(V₁₀₀)]+0.6. Equation (B)

4. A composition comprising:
an ethylene/butene multi-block copolymer having LCB/1000C greater than or equal to 0.06.

5. The composition of claim 4 wherein the ethylene/butene multi-block copolymer comprises from 10 mol % to 30 mol % of butene.

6. The composition of claim 5 wherein the ethylene/butene multi-block copolymer has a rheology ratio (RR) and a viscosity at 0.1 radians per second (V_{0.1}) wherein RR fulfills Equation (A)
RR≥[(−3.0×10⁻⁸)×(V_{0.1})²]+[0.001×(V_{0.1})]+0.85.

7. The composition of claim 6 wherein the ethylene/butene multi-block copolymer has a viscosity at 100 rad/s (V₁₀₀) wherein RR fulfills Equation (B)
RR≥[(2.0×10⁻⁶)×(V₁₀₀)²]+[0.003×(V₁₀₀)]+0.6.

8. The composition of claim 7, wherein the ethylene/butene multi-block copolymer has a rheology ratio (RR) from 1.2 to 10.0.

9. The composition of claim 8 wherein the ethylene/butene multi-block copolymer comprises hard segments and soft segments, the soft segments having melting temperature (SS-Tm) from −5° C. to 30° C.
